(19) United States
(12) Patent Application Publication
(10) Pub. No.: US 2022/0122048 A1
(43) Pub. Date: Apr. 21, 2022

(54) TRANSACTION SYSTEM AND SERVICE PROCESSING METHOD

(71) Applicant: NETSUNION CLEARING CORPORATION, Beijing (CN)

(72) Inventors: Qun Li Qiang, Beijing (CN); Yunping Li, Beijing (CN); Jianjun Zheng, Beijing (CN); Xiang Lu, Beijing (CN); Wenhan Zhang, Beijing (CN); Yong Wang, Beijing (CN); Hong Chen, Beijing (CN); Zongqiu Bai, Beijing (CN); Tianbao Meng, Beijing (CN); Peng Zhang, Beijing (CN); Ping Li, Beijing (CN); Cong Wang, Beijing (CN); Chao Zhuo, Beijing (CN); Fangzhou Peng, Beijing (CN)

(21) Appl. No.: 17/423,781

(22) PCT Filed: Jan. 19, 2020
(86) PCT No.: PCT/CN2020/073049

§ 371 Date: Jul. 16, 2021

(30) Foreign Application Priority Data
Jan. 24, 2019 (CN) 201910070914.8

(51) Int. Cl. G06Q 20/10; G06Q 20/22

(52) U.S. Cl. CPC G06Q 20/10; G06Q 20/227

(57) ABSTRACT

A transaction system, comprising: a first-grade account, wherein the first-grade account is a platform-grade master account which is configured to receive external imported funds and can distribute the external imported funds to a second-grade account; the second-grade account is configured to receive the funds distributed by the first-grade account, and can distribute the received funds distributed by the first-grade account to a third-grade account; the third-grade account is configured to undertake a user-oriented transaction service; wherein when the transaction service undertaken by the third-grade account is a withdrawal service, a withdrawal amount is deducted from the third-grade account; and when the withdrawal amount deducted from the third-grade account is less than a total withdrawal amount corresponding to a current withdrawal service, the second-grade account is requested to retrieve a first residual withdrawal amount which is an amount obtained by subtracting the withdrawal amount deducted from the third-grade account from the total withdrawal amount corresponding to the current withdrawal service. A service processing method is also provided.

### CROSS-REFERENCES TO RELATED APPLICATION

The present application claims priority to Chinese patent application No. 201910070914.8 filed by NetsUnion Clearing Corporation on Jan. 24, 2019 and entitled “Transaction System and Service Processing Method”, the entire contents of which are herein incorporated by reference.

### TECHNICAL FIELD

The present disclosure relates to the field of computer technology, and more specifically, to a transaction system and service processing method.

### BACKGROUND

At present, in order to solve the problem of depositing funds into and withdrawing funds from hot accounts, discrete accounts, credit granting and batch models are usually used for processing. If the discrete account model is adopted, the fund distribution model needs to be designed accordingly. The existing fund distribution models in the prior art include the method of evenly split accounts and the method of large and small accounts.

1. Method of Evenly Split Accounts

As shown in FIG. 1, when external funds are transferred to the master account, the master account receives the funds and evenly distributes the funds to each withdrawal sub-account. The withdrawal service accesses each sub-account at any time, and the sub-accounts implement the transaction processing. If the amount limit of the sub-account is insufficient, the aggregation task must be manually triggered to aggregate all funds into the master account, and then the transaction will be undertaken by the master account. During the transaction processing, the depositing service is routed to the deposit sub-account for regular processing (not shown in FIG. 1), and the funds are aggregated to the master account at regular intervals; the withdrawal service is randomly routed to a sub-account where funds currently exist.

However, the inventors found that there are many problems in the actual application of the method of evenly split accounts, specifically, as shown in (1) to (5).

(1) The method that all funds are evenly split into sub-accounts can be applied to the “high-frequency small-amount” (referring to the situation where the balance of a single withdrawal sub-account is sufficient and the transaction frequency is high) withdrawal transactions, but is not applicable to the “large-amount low-frequency” (referring to the situation where the balance of a single withdrawal sub-account is insufficient and the overall funds are sufficient) withdrawal transactions.

(2) When routing the withdrawal transaction, the current account balance of each sub-account needs to be checked first, which consumes a lot of checking resources, and cannot support a large number of sub-accounts, and thus the measures of dispersion is limited.

(3) The measures of dispersion contradict the upper limit of the single withdrawal amount that can be supported. If it is necessary to support a larger amount of withdrawal, it cannot be sufficiently dispersed; if it is sufficiently dispersed, the amount of funds deposited in a single withdrawal sub-account will decrease.

(4) When making large amount withdrawals, manual aggregation is required, and the user needs to make an appointment in advance, which will affect the processing of real-time transactions.

(5) When a large amount withdrawal transaction is performed, all funds are aggregated into the master account. At this time, the concurrent processing capacity of the system is reduced, and high-frequency withdrawal transactions and large-amount withdrawal transactions cannot be compatible at the same time.

2. Method of Large and Small Accounts

As shown in FIG. 2, external funds are first transferred to the large account, and then the large account regularly allocates funds to each small withdrawal account. In addition, there is another deposit account to handle the depositing service. During the transaction processing, it is first routed according to the type of depositing and withdrawal. If it is a depositing transaction, it will be sent to the deposit account for processing; if it is a withdrawal transaction, it will be routed according to the transaction amount. If the transaction amount is greater than a threshold, it will be routed to a large account for processing; if it is less than or equal to the threshold, it will be randomly routed to a small withdrawal account for processing.

However, the inventors found that the large and small accounts method also has many problems in the actual application process, specifically, as shown in (6) to (8).

(6) When the funds are partially dispersed to the withdrawal sub-accounts, and a single withdrawal transaction amount is greater than the funds deposited in the “large account” but less than the overall amount of funds, the situation that the funds are sufficient but a transaction fails will occur, which will affect the customer experience.

(7) Funds are mainly kept in the master account and are relatively concentrated. If the master account fails, the customer's main liquidity will be unavailable.

(8) Under the distributed architecture, the failure probability of each account is the same, but the fund distribution is different, which will cause the disaster tolerance and fault tolerance to be related to the account in which the failure occurs, and strong disaster tolerance and fault tolerance cannot be achieved.

In sum, in the process of implementing the concept of the present disclosure, the inventors found that the prior art at least has the following problem:

the distribution of funds among accounts in the discrete account system is unreasonable and cannot be effectively applied to service processing in high-concurrency scenarios.

### SUMMARY

In view of this, the present disclosure provides a transaction system and service processing method.

An aspect of the present disclosure provides a transaction system, comprising: a first-grade account, wherein the first-grade account is a platform-grade master account which is configured to receive external imported funds and can distribute the external imported funds to the second-grade account; the second-grade account is configured to receive the funds distributed by the first-grade account, and can distribute the received funds distributed by the first-grade account to a third-grade account; the third-grade account is configured to undertake user-oriented transaction service; wherein when the transaction service undertaken by the third-grade account is a withdrawal service, a withdrawal amount is deducted from the third-grade account; and when the withdrawal amount deducted from the third-grade account is less than a total withdrawal amount corresponding to a current withdrawal service, the second-grade account is requested to retrieve a first residual withdrawal amount which is an amount obtained by subtracting the withdrawal amount deducted from the third-grade account from the total withdrawal amount corresponding to the current withdrawal service.

According to an embodiment of the present disclosure, there are a plurality of the second-grade accounts, and the plurality of the second-grade accounts can transfer funds to each other.

According to an embodiment of the present disclosure, when the withdrawal amount deducted from the third-grade account is less than a total withdrawal amount corresponding to a current withdrawal service, the second-grade account is requested to retrieve a first residual withdrawal amount comprises: a second-grade account that has an associated relationship with the third-grade account is requested to retrieve the first residual withdrawal amount, wherein the second-grade account that has an associated relationship with the third-grade account is one or more of the plurality of the second-grade accounts.

According to an embodiment of the present disclosure, if the second-grade account that has an associated relationship with the third-grade account reports that the amount in the second-grade account is less than the first residual withdrawal amount requested to be retrieved, after retrieving the amount in the second-grade account that has an associated relationship with the third-grade account, another second-grade account is further requested to retrieve a second residual withdrawal amount, wherein the another second-grade account is different from the second-grade account that has an associated relationship with the third-grade account, and the second residual withdrawal amount is an amount obtained by subtracting the amount in the second-grade account that has an associated relationship with the third-grade account from the first residual withdrawal amount.

According to an embodiment of the present disclosure, if the another second-grade account reports that the amount in the account is less than the second residual withdrawal amount, after retrieving a residual amount in the another second-grade account, residual amounts in one or more second-grade accounts of the plurality of the second-grade accounts are aggregated; and the aggregated funds are used to make up the second residual withdrawal amount.

According to an embodiment of the present disclosure, the transaction system comprises a fund allocation module configured to realize mutual transfer of funds among a plurality of the second-grade accounts.

According to an embodiment of the present disclosure, the fund allocation module comprises: an acquisition unit configured to acquire current fund balances of a plurality of the second-grade accounts; a calculation unit configured to calculate an average value and a deviation degree according to the current fund balances of the plurality of second-grade accounts, wherein the current fund balances of the plurality of second-grade accounts include a maximum fund balance and a minimum fund balance, and the deviation degree is calculated based on the maximum fund balance and the minimum fund balance; and an allocation unit configured to allocate a fund balance in a target account whose current fund balance is greater than the average value when the deviation degree is greater than a first threshold, wherein the target account is one or more of a plurality of the second-grade accounts.

According to an embodiment of the present disclosure, the transaction system further comprises a special account configured to aggregate part or all of the funds from the second-grade account and release the aggregated funds to the first-grade account.

According to an embodiment of the present disclosure, the transaction system has a corresponding fund distribution model configured to realize fund distribution among the first-grade account, the second-grade account, and the third-grade account.

According to an embodiment of the present disclosure, the fund distribution model comprises at least a first distribution model, a second distribution model, and a third distribution model; when a total amount of funds in the transaction system is less than a second threshold, the fund distribution model is maintained or switched to the first distribution model; when a quantity of withdrawal services of the transaction system is less than a third threshold, the fund distribution model is maintained or switched to the second distribution model; when a quantity of withdrawal services of the transaction system is greater than or equal to a fourth threshold, the fund distribution model is maintained or switched to the third distribution model.

Another aspect of the present disclosure provides a service processing method comprising: when a transaction service undertaken by a third-grade account is a withdrawal service, a withdrawal amount is deducted from the third-grade account; and when the withdrawal amount deducted from the third-grade account is less than a total withdrawal amount corresponding to a current withdrawal service, a second-grade account is requested to retrieve a first residual withdrawal amount which is an amount obtained by subtracting the amount deducted from the third-grade account from the total withdrawal amount corresponding to the current withdrawal service; wherein the third-grade account is configured to undertake a user-oriented transaction service; the second-grade account is configured to receive the funds distributed by a first-grade account, and can distribute the received funds distributed by the first-grade account to the third-grade account; the first-grade account is configured to receive external imported funds and can distribute the external imported funds to the second-grade account, and the first-grade account is a platform-grade master account.

According to an embodiment of the present disclosure, there are a plurality of the second-grade accounts, and the plurality of the second-grade accounts can transfer funds to each other.

According to an embodiment of the present disclosure, wherein when the withdrawal amount deducted from the third-grade account is less than a total withdrawal amount corresponding to a current withdrawal service, the second-grade account is requested to retrieve a first residual withdrawal amount comprises: a second-grade account that has an associated relationship with the third-grade account is requested to retrieve the first residual withdrawal amount, wherein the second-grade account that has an associated relationship with the third-grade account is one or more of the plurality of the second-grade accounts.

According to an embodiment of the present disclosure, if the second-grade account that has an associated relationship with the third-grade account reports that the amount in the second-grade account is less than the first residual withdrawal amount requested to be retrieve, after retrieving the amount in the second-grade account that has an associated relationship with the third-grade account, another second-grade account is further requested to retrieve a second residual withdrawal amount, wherein the another second-grade account is different from the second-grade account that has an associated relationship with the third-grade account, and the second residual withdrawal amount is an amount obtained by subtracting the amount in the second-grade account that has an associated relationship with the third-grade account from the first residual withdrawal amount.

According to an embodiment of the present disclosure, if the another second-grade account reports that the amount in the account is less than the second residual withdrawal amount, after retrieving a residual amount in the another second-grade account, residual amounts in one or more second-grade accounts of the plurality of the second-grade accounts are aggregated; and the aggregated funds are used to make up the second residual withdrawal amount.

Another aspect of the present disclosure provides a computer system comprising a processor and a computer-readable storage medium, wherein the computer-readable storage medium stores computer-executable instructions, and the instructions are configured to implement the above methods when executed by the processor.

Another aspect of the present disclosure provides a computer-readable storage medium storing computer-executable instructions, and the instructions are configured to implement the above methods when executed

Another aspect of the present disclosure provides a computer program comprising computer-executable instructions, and the instructions are configured to implement the above methods when executed

According to the embodiments of the present disclosure, the present disclosure constructs a three-grade discrete account system through a “vertical hierarchy and horizontal partitioning” account construction method, and realizes the vertical distribution of funds through multi-grade management. When the transaction service undertaken by the third-grade account is a withdrawal service, a withdrawal amount is deducted from the third-grade account; and when the withdrawal amount deducted from the third-grade account is less than a total withdrawal amount corresponding to the current withdrawal service, the second-grade account is requested to retrieve a first residual withdrawal amount which is an amount obtained by subtracting the withdrawal amount deducted from the third-grade account from the total withdrawal amount corresponding to the current withdrawal service. The “high-frequency small-amount” withdrawals service and “low-frequency large-amount” withdrawals service can be compatible at the same time, the dynamic circulation among discrete accounts can be realized, thereby improving capital utilization efficiency and achieving the goal of fully discrete capital by the distributed structure. Therefore, it at least partially overcomes the technical problems in the discrete account system that the distribution of funds among accounts is unreasonable and it cannot be effectively applied to service processing in high-concurrency scenarios, and thus achieves the technical effects of realizing dynamic capital circulation, improving capital utilization efficiency and being applicable to the service processing in high-concurrency scenarios.

### BRIEF DESCRIPTION OF DRAWINGS

Through the following description of the embodiments of the present disclosure with reference to the accompanying drawings, the above and other objectives, features, and advantages of the present disclosure will be more apparent. In the accompanying drawings:

FIG. 1 is a schematic view of a system architecture of the method of evenly split accounts in the prior art;

FIG. 2 is a schematic view of a system architecture of the method of large and small accounts in the prior art;

FIG. 3 is a schematic view of an exemplary system architecture that can use a transaction system and service processing method according to an embodiment of the present disclosure;

FIG. 4 is a schematic view of functions of a centralized platform account according to an embodiment of the present disclosure;

FIG. 5 is a schematic view of functions of IDC accounts according to an embodiment of the present disclosure;

FIG. 6 is a schematic view of functions of a withdrawal sub-account according to an embodiment of the present disclosure;

FIG. 7 is a schematic view of functions of a deposit sub-account according to an embodiment of the present disclosure;

FIG. 8 is a schematic view of functions of a special account according to an embodiment of the present disclosure;

FIG. 9 is a schematic flowchart of a dynamic conversion fund distribution model according to an embodiment of the present disclosure;

FIG. 10 is a schematic flowchart of the work process of a fund allocation module according to an embodiment of the present disclosure;

FIG. 11 is a schematic flowchart of synchronous withdrawal according to an embodiment of the present disclosure;

FIG. 12 is a schematic flowchart of asynchronous withdrawal according to an embodiment of the present disclosure; and

FIG. 13 is a schematic block diagram of a computer system suitable for implementing the methods described above according to an embodiment of the present disclosure.

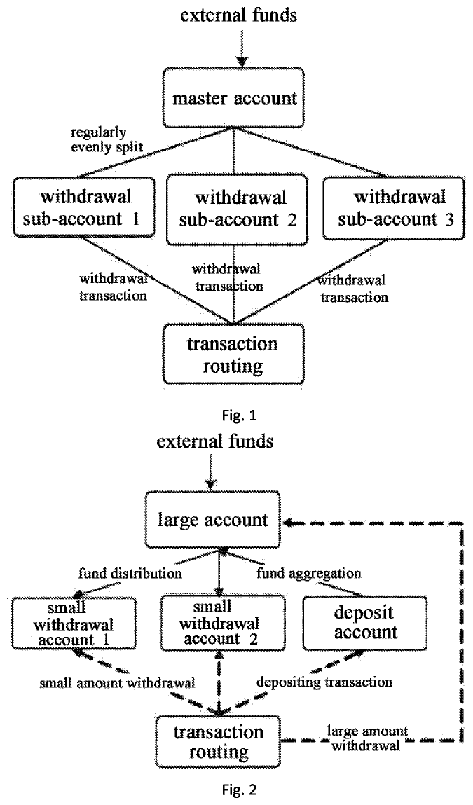

### DETAILED DESCRIPTION

Hereinafter, the embodiments of the present disclosure will be described below with reference to the drawings. However, it should be understood that these descriptions are only exemplary, and are not intended to limit the scope of the present disclosure. In the following detailed description, for ease of explanation, many specific details are set forth to provide a comprehensive understanding of the embodiments of the present disclosure. However, it is obvious that one or more embodiments can also be implemented without these specific details. In addition, in the following description, descriptions of well-known structures and technologies are omitted to avoid unnecessarily obscuring the concept of the present disclosure.

The terminology used herein is only for describing specific embodiments, and is not intended to limit the present disclosure. As used herein, the terms “comprises”, “comprising”, “includes” and “including” specify the presence of stated features, steps, operations, and/or components, but do not preclude the presence or addition of one or more other features, steps, operations, and/or components.

All terms (including technical and scientific terms) used herein have the meanings commonly understood by a person skilled in the art, unless otherwise defined. It should be noted that the terms used herein should be interpreted as having meanings consistent with the context of this specification, and should not be interpreted in an idealized or overly rigid manner.

In the case of using an expression such as “at least one of A, B and C, etc.”, generally speaking, it should be interpreted according to the meaning of the expression commonly understood by those skilled in the art (for example, “a system having at least one of A, B and C” shall include, but is not limited to, a system having A alone, a system having B alone, a system having C alone, a system having A and B, a system having A and C, a system having B and C, and/or a systems having A, B and C, etc.).

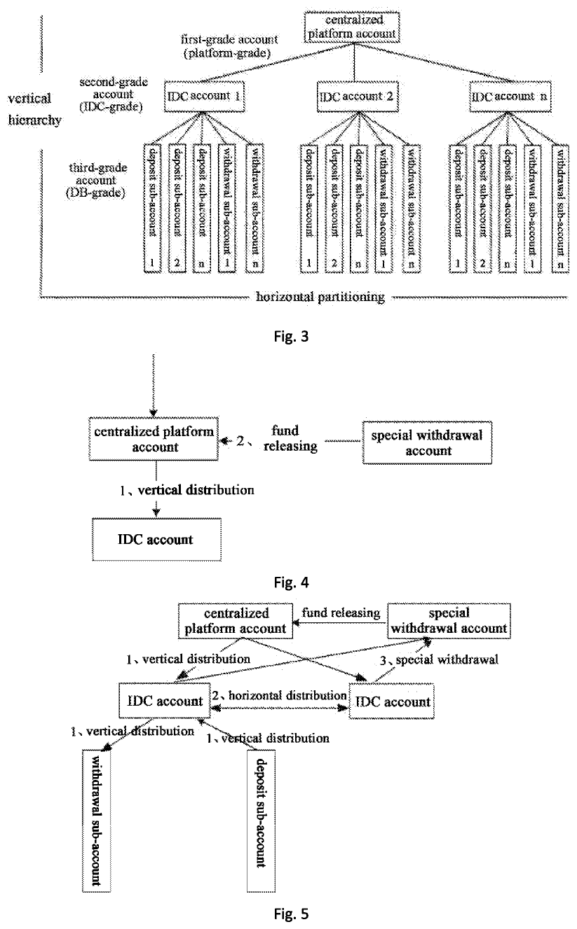

FIG. 3 is a schematic view of an exemplary system architecture 100 that can use a transaction system and service processing method according to an embodiment of the present disclosure. It should be noted that FIG. 3 is only an example of the system architecture that can use the embodiments of the present disclosure, so as to help those skilled in the art understand the technical content of the present disclosure, but it does not mean that the embodiments of the present disclosure cannot be used in other devices, systems, environments or scenarios.

It should be understood that the numbers of first-grade accounts, second-grade accounts, and third-grade accounts in FIG. 3 are only illustrative. According to implementation needs, there may be any number of first-grade accounts, second-grade accounts, and third-grade accounts.

As shown in FIG. 3, the system architecture 100 according to this embodiment may comprise a first-grade account, a second-grade account, and a third-grade account. The first-grade account is a platform-grade master account which is configured to receive external imported funds and can distribute the external imported funds to the second-grade account; the second-grade account is configured to receive the funds distributed by the first-grade account, and can distribute the received funds distributed by the first-grade account to the third-grade account; the third-grade account is configured to undertake a user-oriented transaction service.

When the transaction service undertaken by the third-grade account is a withdrawal service, a withdrawal amount is deducted from the third-grade account; and when the withdrawal amount deducted from the third-grade account is less than a total withdrawal amount corresponding to the current withdrawal service, the second-grade account is requested to retrieve a first residual withdrawal amount which is an amount obtained by subtracting the withdrawal amount deducted from the third-grade account from the total withdrawal amount corresponding to the current withdrawal service.

According to an embodiment of the present disclosure, the first-grade account can also be referred to as a centralized platform account, which is collectively referred to as a centralized platform account below; the second-grade account can also be referred to as an IDC (i.e., Internet Date Center) account, which is collectively referred to as an IDC account below; the third-grade account can include withdrawal sub-account and deposit sub-account, which can exist in the data center in the form of a database (DB) in cyberspace.

FIG. 4 is a schematic view of functions of a centralized platform account according to an embodiment of the present disclosure.

As shown in FIG. 4, the centralized platform account can be responsible for overall service processing, such as mapping, de-mapping, error handling, and fund pre-depositing, etc. It receives external funds, distributes funds vertically to IDC accounts, and releases funds from a special withdrawal account.

FIG. 5 is a schematic view of functions of IDC accounts according to an embodiment of the present disclosure.

As shown in FIG. 5, IDC accounts can be used for horizontal and vertical fund distribution. Among them, vertical fund distribution includes: receiving funds from a centralized platform account, allocating funds to withdrawal sub-accounts, and receiving funds from deposit sub-accounts. Horizontal fund distribution is the transfer between different IDC accounts. That is to say, there are a plurality of second-grade accounts, and the plurality of second-grade accounts can transfer funds to each other. When there is a special withdrawal account, funds can be aggregated by the special withdrawal account and deducted by batch processing accounts for small withdrawals.

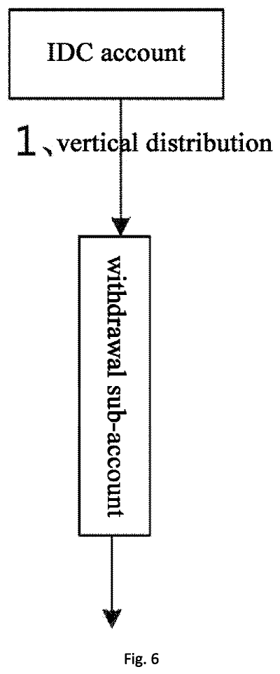

FIG. 6 is a schematic view of functions of a withdrawal sub-account according to an embodiment of the present disclosure.

As shown in FIG. 6, the withdrawal sub-account directly undertakes withdrawals, the construction quantity can be determined by the concurrent amount, and it can receive the funds distributed by the IDC account.

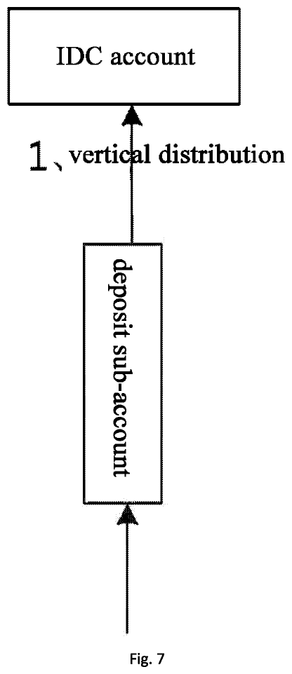

FIG. 7 is a schematic view of functions of a deposit sub-account according to an embodiment of the present disclosure.

As shown in FIG. 7, the deposit sub-account directly undertakes depositing, the construction quantity can be determined by the concurrent amount, and it can deliver the funds to the IDC account.

According to an embodiment of the present disclosure, the transaction system may further comprise a special account for aggregating part or all of the funds from the second-grade account and releasing the aggregated funds to the first-grade account.

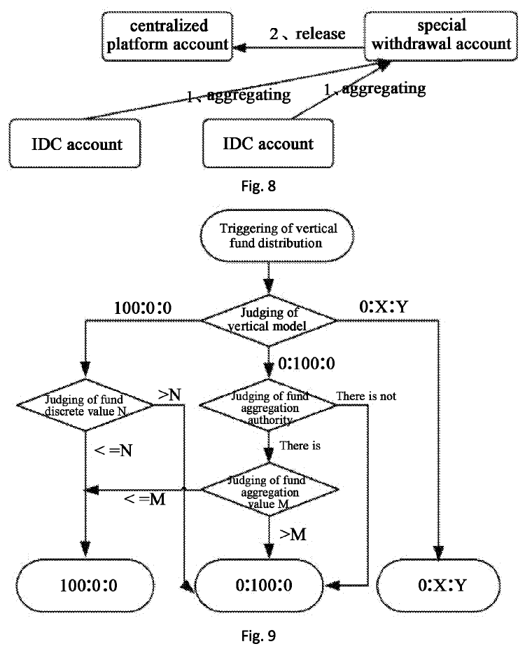

FIG. 8 is a schematic view of functions of a special account according to an embodiment of the present disclosure.

According to an embodiment of the present disclosure, when the special account is used for withdrawals, it can be referred to as a special withdrawal account. As shown in FIG. 8, the special withdrawal account can aggregate funds from the IDC account in proportion for the first time, aggregate the balance from the IDC account for the second time, and release the aggregated funds to the centralized platform account. The special withdrawal account can be used for large-amount withdrawal services.

According to an embodiment of the present disclosure, each account cluster can be deployed in different centers in a distributed manner. Each center is provided with a centralized platform account which may be in a one-master-five-slave state and can switch and undertake services at any time, an IDC account in an available state, multiple withdrawal and deposit sub-accounts which are all in an available state. Each IDC account is associated with multiple withdrawal and deposit sub-accounts, thereby realizing horizontal partitioning.

According to the embodiments of the present disclosure, the present disclosure constructs a three-grade discrete account system through a “vertical hierarchy and horizontal partitioning” account construction method, and realizes the vertical distribution of funds through multi-grade management. When the transaction service undertaken by the third-grade account is a withdrawal service, a withdrawal amount is deducted from the third-grade account; and when the withdrawal amount deducted from the third-grade account is less than a total withdrawal amount corresponding to the current withdrawal service, the second-grade account is requested to retrieve a first residual withdrawal amount which is an amount obtained by subtracting the withdrawal amount deducted from the third-grade account from the total withdrawal amount corresponding to the current withdrawal service. The “high-frequency small-amount” withdrawals and “low-frequency large-amount” withdrawals can be compatible at the same time, the dynamic circulation among discrete accounts can be realized, thereby improving capital utilization efficiency and achieving the goal of fully discrete capital by the distributed architecture. Therefore, it at least partially overcomes the technical problems in the discrete account system that the distribution of funds among accounts is unreasonable and it cannot be effectively applied to service processing in high-concurrency scenarios, and thus achieves the technical effects of realizing dynamic capital circulation, improving capital utilization efficiency and being applicable to the service processing in high-concurrency scenarios.

According to an embodiment of the present disclosure, in order to ensure the reasonable allocation of funds among the accounts in the transaction system, a fund distribution model for realizing the fund distribution among the first-grade accounts, the second-grade accounts, and the third-grade accounts needs to be constructed.

According to an embodiment of the present disclosure, the transaction system has a corresponding fund distribution model, and the fund distribution model is configured to realize the fund distribution among the first-grade accounts, the second-grade accounts, and the third-grade accounts.

According to an embodiment of the present disclosure, the fund distribution model at least includes a first distribution model, a second distribution model, and a third distribution model.

For example, the first distribution model is 100:0:0, wherein the amount in the first-grade account is 100% of the total amount, and the amount in the second-grade account and the amount in the third-grade account are 0% of the total amount, respectively.

The second distribution model is 0:100:0, wherein the amount in the first-grade account is 0% of the total amount, the amount in the second-grade account is 100% of the total amount, and the amount in the third-grade account is 0% of the total amount.

The third distribution model is 0:X:Y, wherein the amount in the first-grade account is 0% of the total amount, the amount in the second-grade account is X % of the total amount, and the amount in the third-grade account is Y % of the total amount, wherein X+Y=100.

According to an embodiment of the present disclosure, different distribution models are mainly determined based on the concurrent amount and fund amount of each payment institution. The basic structure of the account system of each payment institution may be the same, but their fund distribution models may be different, and can be dynamically converted among different fund distribution models.

According to an embodiment of the present disclosure, the transaction system can adjust the fund distribution model according to the current fund situation.

FIG. 9 is a schematic flowchart of a dynamic conversion fund distribution model according to an embodiment of the present disclosure.

According to an embodiment of the present disclosure, as shown in FIG. 9, the transaction system can regularly trigger the vertical fund distribution. The trigger time interval can be set and can be suspended. Each payment institution can judge the current vertical fund distribution model. If the fund distribution model is 0:X:Y model, continue to use this model; if the fund distribution model is 100:0:0 model, read the current funds, and judge whether the current funds are greater than the discrete value N (N can be set and N>M needs to be checked), if the current fund is less than or equal to N, continue to use the 100:0:0 model without processing; if the current fund>N, change the current model to the 0:100:0 model. If the fund distribution model is 0:100:0 model, read the current fund, and judge whether it is less than or equal to the fund aggregation value M (M can be set and N>M needs to be checked), if it is less than or equal to M, change the current model to 100:0:0, if it is greater than M, continue to use the 0:100:0 model without processing.

According to an embodiment of the present disclosure, when the total amount of funds in the transaction system is less than a second threshold, the fund distribution model is maintained or switched to the first distribution model.

According to an embodiment of the present disclosure, when the payment institution's transaction system has insufficient funds, the aggregation is performed, and the current statistical value of funds, i.e., the total amount of funds, is regularly read. If the total amount of funds is less than the second threshold (settable, such as ¥500,000), fund aggregation will be triggered, the current vertical fund distribution model of the payment institution will be maintained or switched to the model 100:0:0. If the total amount of funds is greater than the discrete value N (settable, such as ¥5,000,000), the default vertical fund distribution model of 0:100:0 will be restored.

When the quantity of withdrawal services of the transaction system is less than a third threshold, the fund distribution model is maintained or switched to the second distribution model.

According to an embodiment of the present disclosure, the fund distribution model can be dynamically adjusted according to the peak quantity of the withdrawal services of a single payment institution. When the peak quantity of the withdrawal services is small, for example, less than a third threshold (i.e., 10,000 transactions), the fund distribution model is set to the second distribution model, i.e., 0:100:0 model. The regular task of performing dynamic fund adjustment may be activated, and the centralized platform account will evenly distribute the funds to each IDC account. If there are funds in the withdrawal sub-account, the funds will be transferred to this IDC account.

When the quantity of withdrawal services of the transaction system is greater than or equal to the fourth threshold, the fund distribution model is maintained or switched to the third distribution model; wherein the fourth threshold is greater than the third threshold.

According to an embodiment of the present disclosure, the fund distribution model can be dynamically adjusted according to the peak quantity of the withdrawal services of a single payment institution. When the peak quantity of the withdrawal services is large, for example, greater than or equal to the fourth threshold (i.e., 1,000,000 transactions), the fund distribution model is set to the third distribution model, i.e., 0:X:Y model. The regular task of performing dynamic fund adjustment may be activated, and the centralized platform account will evenly distribute the funds to each IDC account, and each IDC account will make up the funds to the withdrawal sub-account according to a fixed amount.

According to an embodiment of the present disclosure, for a payment institution with a 0:X:Y model, if a single full or nearly full amount withdrawal is made, a large amount withdrawal appointment may be used to temporarily change the vertical fund distribution model to 0:100:0.

According to an embodiment of the present disclosure, the transaction system further includes a fund allocation module for realizing mutual transfer of funds among a plurality of the second-grade accounts. According to an embodiment of the present disclosure, the fund allocation module includes an acquisition unit, a calculation unit, and an allocation unit.

The acquisition unit is configured to acquire the current fund balances of a plurality of the second-grade accounts.

The calculation unit is configured to calculate an average value and a deviation degree based on the current fund balances of a plurality of the second-grade accounts, where the current fund balances of a plurality of the second-grade accounts include the maximum fund balance and the minimum fund balance, and the deviation degree is calculated based on the maximum fund balance and the minimum fund balance.

The allocation unit is configured to allocate the fund balance in the target account whose current fund balance is greater than the average value when the degree of deviation is greater than the first threshold, wherein the target account is one or more of the plurality of the second-grade accounts.

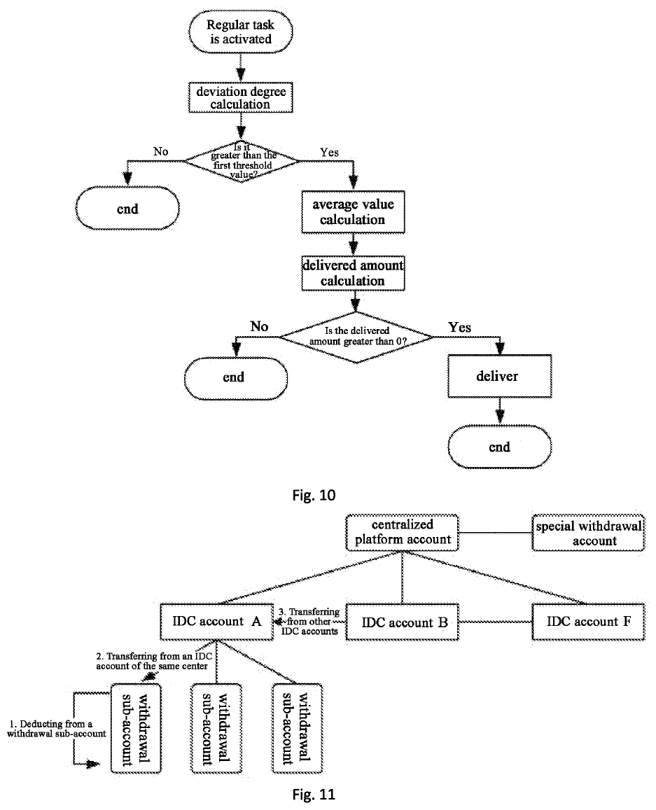

FIG. 10 is a schematic flowchart of the work process of a fund allocation module according to an embodiment of the present disclosure.

As shown in FIG. 10, the regular task can be activated by the fund allocation module to perform the horizontal fund distribution. According to an embodiment of the present disclosure, the regular task may be changed through a management interface (in seconds), and the horizontal fund distribution task may be suspended.

According to the embodiment of the present disclosure, after the regular task is activated, the fund allocation module may read the current funds of the second-grade accounts (i.e., the IDC accounts) that are currently in available state. The maximum fund balance and the minimum fund balance of the IDC accounts are Mₘₐₓ and Mₘᵢₙ, respectively. If there are multiple IDC funds with the same highest or lowest value, one of them is chosen. The deviation degree is calculated, wherein the deviation degree=(Mₘₐₓ−Mₘᵢₙ)/Mₘₐₓ. The fund balances in multiple IDC accounts in available state are added up, and the average value M_{AVG} is calculated.

According to the embodiment of the present disclosure, if the deviation degree is less than or equal to the first threshold value, the process ends; if the deviation degree is greater than the first threshold value, the horizontal fund distribution is activated.

According to the embodiment of the present disclosure, the funds in the IDC account whose current funds are greater than the average value M_{AVG} are allocated, for example, the excess amount is delivered to a special account or a centralized platform account, and the delivered amount is M_{N}−M_{AVG}.

According to the embodiment of the present disclosure, the delivered amount may also be judged. If M_{N}−M_{AVG}>0, it is delivered; if M_{N}−M_{AVG}≤0, it is not delivered.

According to the embodiment of the present disclosure, the fund balances in the target accounts whose current fund balances are greater than the average value are allocated by the fund allocation module, so that the funds are relatively evenly distributed among the accounts, thereby improving disaster tolerance and fault tolerance.

According to the embodiment of the present disclosure, when the withdrawal amount deducted from the third-grade account is less than a total withdrawal amount corresponding to the current withdrawal service, a second-grade account that has an associated relationship with the third-grade account is requested to retrieve the first residual withdrawal amount, wherein the second-grade account that has an associated relationship with the third-grade account is one or more of the plurality of the second-grade accounts.

According to the embodiment of the present disclosure, for example, if the total withdrawal amount corresponding to the current withdrawal service is ¥10,000,000, and there is only ¥2,000,000 in the third-grade account, the withdrawal amount deducted from the third-grade account is ¥2,000,000. In this case, it is insufficient to pay the total withdrawal amount corresponding to the current withdrawal service. A request may be made to the second-grade account to retrieve a first residual withdrawal amount. The first residual withdrawal amount is ¥8,000,000 which is obtained by subtracting ¥2,000,000 from ¥10,000,000.

According to the embodiment of the present disclosure, each third-grade account has a second-grade account which it has an associated relationship with, and can make a request to the second-grade account that has an associated relationship with the third-grade account to retrieve the first residual withdrawal amount.

FIG. 11 is a schematic flowchart of synchronous withdrawal according to an embodiment of the present disclosure.

As shown in FIG. 11, the withdrawal sub-account first deducts the amount in the account itself, and then may make a request to the IDC account of the same center for the transfer of funds, and retrieves the first residual withdrawal amount from the IDC account.

According to the embodiments of the present disclosure, by making a request to the second-grade account that has an associated relationship with the third-grade account to retrieve the first residual withdrawal amount, the efficient transfer of funds among accounts under the distributed-architecture of discrete account system is realized.

According to an embodiment of the present disclosure, if the second-grade account that has an associated relationship with the third-grade account reports that the amount in the second-grade account is less than the first residual withdrawal amount requested to be retrieved, after retrieving the amount in the second-grade account that has an associated relationship with the third-grade account, another second-grade account is requested to retrieve a second residual withdrawal amount, wherein the another second-grade account is different from the second-grade account that has an associated relationship with the third-grade account, and the second residual withdrawal amount is the amount obtained by subtracting the amount in the second-grade account that has an associated relationship with the third-grade account from the first residual withdrawal amount.

According to the embodiments of the present disclosure, if after retrieving the amount in the second-grade account that has an associated relationship with the third-grade account, it is still insufficient to pay the total amount corresponding to the current withdrawal service, another second-grade account is requested to retrieve a second residual withdrawal amount. For example, the total amount corresponding to the current withdrawal service is ¥10,000,000, and there is only ¥2,000,000 in the third-grade account, and the amount in the second-grade account that has an associated relationship with the third-grade account is ¥4,000,000. After the amount in the second-grade account that has an associated relationship with the third-grade account is retrieved, there is still ¥4,000,000 that cannot be paid, and the unpaid ¥4,000,000 is the second residual withdrawal amount. A request may be made to another second-grade account to retrieve ¥4,000,000.

As shown in FIG. 11, another IDC account may be randomly selected to retrieve the balance of funds.

According to an embodiment of the present disclosure, if the another second-grade account reports that the amount in the another second-grade account is less than the second residual withdrawal amount, residual amounts in one or more second-grade accounts of the plurality of the second-grade accounts are aggregated after the residual amount in the another second-grade account is retrieved; and the aggregated funds are used to make up the second residual withdrawal amount.

According to an embodiment of the present disclosure, one or more residual second-grade accounts in the plurality of second-grade accounts refer to other second-grade accounts except the second-grade accounts from which an amount has been deducted. For example, the second-grade accounts from which the amounts have been deducted include the second-grade account that has an associated relationship with the third-grade account and the another second-grade account.

Specifically, for example, a certain payment institution includes a second-grade account A, a second-grade account B, a second-grade account C, and a second-grade account D. If both the second-grade account A and the second-grade account B have been deducted an amount, and at this point it is still insufficient to pay the total amount corresponding to the current withdrawal service, the amounts in the second-grade account C and the second-grade account D may be aggregated, and the aggregated funds are used to make up the residual amount.

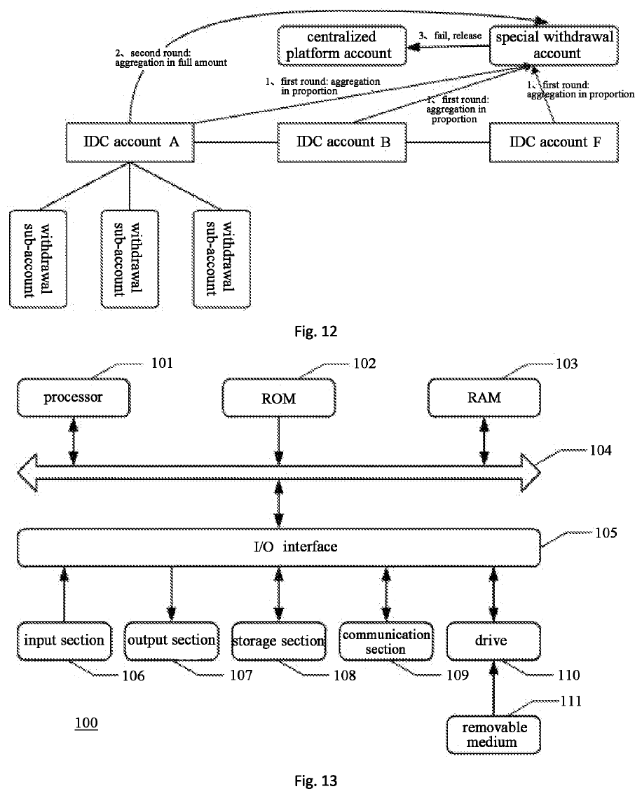

FIG. 12 is a schematic flowchart of asynchronous withdrawal according to an embodiment of the present disclosure.

As shown in FIG. 12, if after retrieving the residual amount in the another second-grade account, it is still insufficient to pay the total amount corresponding to the current withdrawal service, fund aggregation may be performed on the residual second-grade accounts in proportion or in full amount. For example, fund aggregation may be performed on IDC account A, IDC account B, and IDC account F in proportion. Fund aggregation may be performed on IDC account A, IDC account B, and IDC account F in full amount.

According to an embodiment of the present disclosure, alternatively, first, fund aggregation may be performed on the residual second-grade accounts in proportion, the aggregated funds are delivered to the special withdrawal account and then released from the special withdrawal account to the centralized platform account, and then the centralized platform account pays the residual funds; or the centralized platform account first allocates the funds in the account to one of the IDC accounts through the vertical distribution, and then the IDC account allocates the funds to the corresponding withdrawal sub-account. When it is still insufficient to pay the total amount corresponding to the current withdrawal service, fund aggregation is then performed on the residual second-grade accounts in full amount.

According to the embodiment of the present disclosure, if after the fund aggregation in full amount, the current funds of the special withdrawal account are still less than the total withdrawal amount corresponding to the current withdrawal service, a failure response may be sent back, and the special withdrawal account will release the funds to the centralized platform account.

According to the embodiment of the present disclosure, after the synchronous withdrawal process fails, the asynchronous withdrawal method may be applied to the “large-amount low-frequency” withdrawal services.

Table 1 schematically shows the quantity of withdrawal services handled in a day using the transaction system according to the embodiment of the present disclosure.

TABLE 1

| | | average | | | |
|---|---|---|---|---|---|
| withdrawal | number of | response | | | percentage of |
| account grade | transactions | time | | ratio | success |
| third-grade | 117,000,000 | 6.23 | ms | 99.13% | 100.00% |
| second-grade | 964,100 | 12.65 | ms | 0.81% | 100.00% |
| first-grade | 66,900 | 48.63 | ms | 0.06% | 100.00% |
| special withdrawal | 4 | 323 | ms | 0.00% | 100.00% |

According to the embodiment of the present disclosure, the transaction system of the present disclosure can be applied to the pre-payment hotspot account pre-end system. As shown in Table 1, on a certain day, a total of 117,000,000 withdrawal services were processed and the peak value was greater than 3000 TPS. The distribution of withdrawals from the accounts at all grades is shown in Table 1.

According to the embodiment of the present disclosure, the actual operation results of the transaction system prove that the account structure, fund distribution, and service processing solutions provided by the present disclosure can solve hotspot account problems, and the multi-grade withdrawal solution can play a role, and the “high-frequency small-value” and “low-frequency large-value” withdrawal services can be compatible.

The present disclosure also provides a service processing method, comprising: when a transaction service undertaken by a third-grade account is a withdrawal service, a withdrawal amount is deducted from the third-grade account; and when the withdrawal amount deducted from the third-grade account is less than a total withdrawal amount corresponding to a current withdrawal service, a second-grade account is requested to retrieve a first residual withdrawal amount which is an amount obtained by subtracting the withdrawal amount deducted from the third-grade account from the total withdrawal amount corresponding to the current withdrawal service; wherein the third-grade account is configured to undertake a user-oriented transaction service; the second-grade account is configured to receive the funds distributed by a first-grade account, and can distribute the received funds distributed by the first-grade account to the third-grade account; the first-grade account is configured to receive external imported funds and can distribute the external imported funds to the second-grade account, and the first-grade account is a platform-grade master account.

According to the embodiment of the present disclosure, the present disclosure constructs a three-grade discrete account system through a “vertical hierarchy and horizontal partitioning” account construction method, and realizes the vertical distribution of funds through multi-grade management. When the transaction service undertaken by the third-grade account is a withdrawal service, a withdrawal amount is deducted from the third-grade account; and when the withdrawal amount deducted from the third-grade account is less than a total withdrawal amount corresponding to the current withdrawal service, the second-grade account is requested to retrieve a first residual withdrawal amount which is an amount obtained by subtracting the withdrawal amount deducted from the third-grade account from the total withdrawal amount corresponding to the current withdrawal service. The “high-frequency small-amount” withdrawal services and “low-frequency large-amount” withdrawal services can be compatible at the same time, the dynamic circulation among discrete accounts can be realized, thereby improving capital utilization efficiency and achieving the goal of fully discrete capital by the distributed architecture. Therefore, it at least partially overcomes the technical problems in the discrete account system that the distribution of funds among accounts is unreasonable and it cannot be effectively applied to service processing in high-concurrency scenarios, and thus achieves the technical effects of realizing dynamic capital circulation, improving capital utilization efficiency and being applicable to the service processing in high-concurrency scenarios.

According to an embodiment of the present disclosure, there are a plurality of the second-grade accounts, and the plurality of the second-grade accounts can transfer funds to each other.

According to an embodiment of the present disclosure, wherein when the amount deducted from the third-grade account is less than a total withdrawal amount corresponding to a current withdrawal, the second-grade account is requested to retrieve a first residual withdrawal amount comprises: a second-grade account that has an associated relationship with the third-grade account is requested to retrieve the first residual withdrawal amount, wherein the second-grade account that has an associated relationship with the third-grade account is one or more of the plurality of the second-grade accounts.

According to an embodiment of the present disclosure, if the second-grade account that has an associated relationship with the third-grade account reports that the amount in the second-grade account is less than the first residual withdrawal amount requested to be retrieved, after retrieving the amount in the second-grade account that has an associated relationship with the third-grade account, another second-grade account is further requested to retrieve a second residual withdrawal amount, wherein the another second-grade account is different from the second-grade account that has an associated relationship with the third-grade account, and the second residual withdrawal amount is an amount obtained by subtracting the amount in the second-grade account that has an associated relationship with the third-grade account from the first residual withdrawal amount.

According to an embodiment of the present disclosure, if the another second-grade account reports that the amount in the account is less than the second residual withdrawal amount, after retrieving a residual amount in the another second-grade account, amounts in one or more residual second-grade accounts of the plurality of the second-grade accounts are aggregated; and the aggregated funds are used to make up the second residual withdrawal amount.

It should be noted that the part of the service processing method in the embodiment of the present disclosure corresponds to the part of the transaction system in the embodiment of the present disclosure. For the description of the service processing method, please refer to the description in the part of the transaction system, which will not be repeated here.

According to the embodiments of the present disclosure, any number of modules and units according to the embodiments of the present disclosure or at least part of the functions thereof may be implemented in one module. Any number of the modules and units according to the embodiments of the present disclosure may be split into multiple modules for implementation. Any number of the modules and units according to the embodiments of the present disclosure may be at least partially implemented as hardware circuits, for example, field programmable gate array (FPGA), programmable logic array (PLA), system on chip, system on substrate, system on package, application-specific integrated circuit (ASIC), or implemented as hardware or firmware that integrate or package a circuit in any suitable way, or implemented in any one or a suitable combination of the following three ways: software, hardware, and firmware. Alternatively, one or more of the modules, sub-modules, units, and sub-units according to the embodiments of the present disclosure may be at least partially implemented as a computer program module, and when the computer program module is executed, the corresponding function may be performed.

For example, any number of the acquisition unit, the calculation unit, and the allocation unit can be combined into one module/unit/sub-unit for implementation; alternatively, any one of the modules/units/sub-units can be split into multiple modules/units/sub-units. Alternatively, at least part of the functions of one or more of these modules/units/sub-units can be combined with at least part of the functions of other modules/units/sub-units, and implemented in one module/unit/sub-unit. According to an embodiment of the present disclosure, at least one of the acquisition unit, the calculation unit, and the allocation unit may be at least partially implemented as hardware circuits, for example, field programmable gate array (FPGA), programmable logic array (PLA), system on chip, system on substrate, system on package, application-specific integrated circuit (ASIC), or implemented as hardware or firmware that integrate or package a circuit in any suitable way, or implemented in any one or a suitable combination of the following three ways: software, hardware, and firmware. Alternatively, at least one of the acquisition unit, the calculation unit, and the allocation unit may be at least partially implemented as a computer program module, and when the computer program module is executed, the corresponding function may be performed.

FIG. 13 is a schematic block diagram of a computer system suitable for implementing the methods described above according to an embodiment of the present disclosure. The computer system shown in FIG. 13 is only an example, and should not bring any limitation to the function and application range of the embodiments of the present disclosure.

As shown in FIG. 13, a computer system 100 according to an embodiment of the present disclosure includes a processor 101, which performs a variety of appropriate actions and processing according to a program stored in a read only memory (ROM) 103 or loaded from a storage section 108 into a random access memory (RAM) 103. The processor 101 may include, for example, a general-purpose microprocessor (for example, a CPU), an instruction set processor and/or a related chipset and/or a special purpose microprocessor (for example, an application specific integrated circuit (ASIC)), and so on. The processor 101 may also include on-board memory for caching purposes. The processor 101 may include a single processing unit or multiple processing units for executing different actions of a method flow according to the embodiments of the present disclosure.

In the RAM 103, various programs and data necessary for the operation of the system 100 are stored. The processor 101, the ROM 102, and the RAM 103 are connected to each other through a bus 104. The processor 101 executes various operations of the method flow according to the embodiments of the present disclosure by executing programs in the ROM 102 and/or RAM 103. It should be noted that the program can also be stored in one or more memories other than the ROM 102 and the RAM 103. The processor 101 may also execute various operations of the method flow according to the embodiments of the present disclosure by executing programs stored in the one or more memories.

According to an embodiment of the present disclosure, the system 100 may further include an input/output (I/O) interface 105, and the input/output (I/O) interface 105 is also connected to the bus 104. The system 100 may also include one or more of the following components connected to the I/O interface 105: an input section 106 including a keyboard, a mouse, etc.; an output section 107 including a cathode ray tube (CRT), a liquid crystal display (LCD), etc. and a speaker, etc.; a storage section 108 including a hard disk, etc.; and a communication section 109 including the network interface card such as a LAN card, a modem, etc. The communication section 109 performs communication processing via a network such as the Internet. The drive 110 is also connected to the I/O interface 105 as needed. A removable medium 111, such as a magnetic disk, an optical disk, a magneto-optical disk, a semiconductor memory, etc., is installed on the drive 110 as needed, so that the computer program read from it is installed into the storage section 108 as needed.

According to the embodiment of the present disclosure, the method flow according to the embodiment of the present disclosure may be implemented as a computer software program. For example, an embodiment of the present disclosure includes a computer program product, which includes a computer program carried on a computer-readable storage medium, and the computer program contains program codes for executing the method shown in the flowchart. In such an embodiment, the computer program may be downloaded and installed from the network through the communication section 109, and/or installed from the removable medium 111. When the computer program is executed by the processor 101, the above functions defined in the system of the embodiments of the present disclosure are executed. According to the embodiments of the present disclosure, the systems, devices, devices, modules, units, etc. described above may be implemented by computer program modules.

The present disclosure also provides a computer-readable storage medium. The computer-readable storage medium may be included in the device/apparatus/system described in the above embodiment; or it may exist alone without being assembled into the device/apparatus/system. The computer-readable storage medium carries one or more programs, and when the one or more programs are executed, the method according to the embodiments of the present disclosure is implemented.

According to an embodiment of the present disclosure, the computer-readable storage medium may be a non-volatile computer-readable storage medium. For example, it may include, but not limited to: portable computer disk, hard disk, random access memory (RAM), read-only memory (ROM), erasable programmable read-only memory (EPROM or flash memory), portable compact disk read-only memory (CD-ROM), optical storage device, magnetic storage device, or any suitable combination of the above. In the present disclosure, a computer-readable storage medium may be any tangible medium that contains or stores a program, and the program may be used by or in combination with an instruction execution system, apparatus, or device.

For example, according to an embodiment of the present disclosure, the computer-readable storage medium may include the ROM 102 and/or the RAM 103 described above and/or one or more memories other than the ROM 102 and the RAM 103.

The flowcharts and block diagrams in the accompanying drawings illustrate the architecture, functionality, and operation of possible implementations of systems, methods, and computer program products according to various embodiments of the present disclosure. In this regard, each block in the flowchart or block diagram can represent a module, a program segment, or a part of code, and the above module, program segment, or part of code contains one or more executable instructions for realizing the specified logic functions. It should also be noted that, in some alternative implementations, the functions indicated in the block may also occur in a different order from the order shown in the drawings. For example, two blocks shown in succession can actually be executed substantially in parallel, and they can sometimes be executed in the reverse order, depending on the functions involved. It should also be noted that each block in the block diagram or flowchart, and the combinations of blocks in the block diagram or flowchart, may be implemented by a dedicated hardware-based system that performs the specified functions or operations, or may be implemented by a combination of dedicated hardware and computer instructions.

Those skilled in the art can understand that the features recited in the various embodiments of the present disclosure and/or the claims can be combined or incorporated in various ways, even if such combinations or incorporations are not explicitly recited in the present disclosure. In particular, without departing from the spirit and teachings of the present disclosure, the features recited in the various embodiments of the present disclosure and/or the claims can be combined or incorporated in various ways. All these combinations and/or incorporations fall within the scope of the present disclosure.

The embodiments of the present disclosure have been described above. However, these embodiments are for illustrative purposes only, and are not intended to limit the scope of the present disclosure. Although the respective embodiments are described above, it does not mean that the methods in the respective embodiments cannot be advantageously used in combination. The scope of the present disclosure is defined by the appended claims and their equivalents. Without departing from the scope of the present disclosure, those skilled in the art can make various substitutions and modifications which should all fall within the scope of the present disclosure.

1. A transaction system, comprising:
a first-grade account,
wherein the first-grade account is a platform-grade master account which is configured to receive external imported funds and can distribute the external imported funds to a second-grade account;
the second-grade account is configured to receive the funds distributed by the first-grade account, and can distribute the received funds distributed by the first-grade account to a third-grade account;
the third-grade account is configured to undertake a user-oriented transaction service;
wherein when the transaction service undertaken by the third-grade account is a withdrawal service, a withdrawal amount is deducted from the third-grade account; and when the withdrawal amount deducted from the third-grade account is less than a total withdrawal amount corresponding to a current withdrawal service, the second-grade account is requested to retrieve a first residual withdrawal amount which is an amount obtained by subtracting the withdrawal amount deducted from the third-grade account from the total withdrawal amount corresponding to the current withdrawal service.

2. The system according to claim 1, wherein there are a plurality of the second-grade accounts, and the plurality of the second-grade accounts can transfer funds to each other.

3. The system according to claim 1, wherein when the withdrawal amount deducted from the third-grade account is less than a total withdrawal amount corresponding to a current withdrawal service, the second-grade account is requested to retrieve a first residual withdrawal amount comprises:
a second-grade account that has an associated relationship with the third-grade account is requested to retrieve the first residual withdrawal amount, wherein the second-grade account that has an associated relationship with the third-grade account is one or more of the plurality of the second-grade accounts.

4. The system according to claim 3, wherein if the second-grade account that has an associated relationship with the third-grade account reports that the amount in the second-grade account is less than the first residual withdrawal amount requested to be retrieved, after retrieving the amount in the second-grade account that has an associated relationship with the third-grade account, another second-grade account is further requested to retrieve a second residual withdrawal amount, wherein the another second-grade account is different from the second-grade account that has an associated relationship with the third-grade account, and the second residual withdrawal amount is an amount obtained by subtracting the amount in the second-grade account that has an associated relationship with the third-grade account from the first residual withdrawal amount.

5. The system according to claim 4, wherein if the another second-grade account reports that the amount in the account is less than the second residual withdrawal amount, after retrieving a residual amount in the another second-grade account, residual amounts in one or more second-grade accounts of the plurality of the second-grade accounts are aggregated; and
the aggregated funds are used to make up the second residual withdrawal amount.

6. The system according to any of claim 1, further comprising:
a fund allocation module configured to realize mutual transfer of funds among a plurality of the second-grade accounts.

7. The system according to claim 6, wherein the fund allocation module comprises:
an acquisition unit configured to acquire current fund balances of a plurality of the second-grade accounts;
a calculation unit configured to calculate an average value and a deviation degree according to the current fund balances of the plurality of second-grade accounts, wherein the current fund balances of the plurality of second-grade accounts include a maximum fund balance and a minimum fund balance, and the deviation degree is calculated based on the maximum fund balance and the minimum fund balance; and
an allocation unit configured to allocate a fund balance in a target account whose current fund balance is greater than the average value when the deviation degree is greater than a first threshold, wherein the target account is one or more of a plurality of the second-grade accounts.

8. The system according to any of claim 1, further comprising:
a special account configured to aggregate part or all of the funds from the second-grade account and release the aggregated funds to the first-grade account.

9. The system according to any of claim 1, wherein the transaction system has a corresponding fund distribution model configured to realize fund distribution among the first-grade account, the second-grade account, and the third-grade account.

10. The system according to claim 9, wherein the fund distribution model comprises at least a first distribution model, a second distribution model, and a third distribution model;
when a total amount of funds in the transaction system is less than a second threshold, the fund distribution model is maintained or switched to the first distribution model;
when a quantity of withdrawal services of the transaction system is less than a third threshold, the fund distribution model is maintained or switched to the second distribution model;
when a quantity of withdrawal services of the transaction system is greater than or equal to a fourth threshold, the fund distribution model is maintained or switched to the third distribution model.

11. The system according to claim 10, wherein the fourth threshold is greater than the third threshold.

12. A service processing method, comprising:
when a transaction service undertaken by a third-grade account is a withdrawal service, a withdrawal amount is deducted from the third-grade account; and when the withdrawal amount deducted from the third-grade account is less than a total withdrawal amount corresponding to a current withdrawal service, a second-grade account is requested to retrieve a first residual withdrawal amount which is an amount obtained by subtracting the amount deducted from the third-grade account from the total withdrawal amount corresponding to the current withdrawal service;
wherein the third-grade account is configured to undertake a user-oriented transaction service;
the second-grade account is configured to receive the funds distributed by a first-grade account, and can distribute the received funds distributed by the first-grade account to the third-grade account;
the first-grade account is configured to receive external imported funds and can distribute the external imported funds to the second-grade account, and the first-grade account is a platform-grade master account.

13. The method according to claim 12, wherein there are a plurality of the second-grade accounts, and the plurality of the second-grade accounts can transfer funds to each other.

14. The method according to claim 12 or 13, wherein when the withdrawal amount deducted from the third-grade account is less than a total withdrawal amount corresponding to a current withdrawal service, the second-grade account is requested to retrieve a first residual withdrawal amount comprises:
a second-grade account that has an associated relationship with the third-grade account is requested to retrieve the first residual withdrawal amount, wherein the second-grade account that has an associated relationship with the third-grade account is one or more of the plurality of the second-grade accounts.

15. The method according to 14, wherein if the second-grade account that has an associated relationship with the third-grade account reports that the amount in the second-grade account is less than the first residual withdrawal amount requested to be retrieved, after retrieving the amount in the second-grade account that has an associated relationship with the third-grade account, another second-grade account is further requested to retrieve a second residual withdrawal amount, wherein the another second-grade account is different from the second-grade account that has an associated relationship with the third-grade account, and the second residual withdrawal amount is an amount obtained by subtracting the amount in the second-grade account that has an associated relationship with the third-grade account from the first residual withdrawal amount.

16. The method according to claim 15, wherein if the another second-grade account reports that the amount in the account is less than the second residual withdrawal amount, after retrieving a residual amount in the another second-grade account, residual amounts in one or more second-grade accounts of the plurality of the second-grade accounts are aggregated; and the aggregated funds are used to make up the second residual withdrawal amount.

17. The method according to claim 12, wherein mutual transferring funds among the plurality of the second-grade accounts comprises:
acquiring current fund balances of a plurality of the second-grade accounts;
calculating an average value and a deviation degree according to the current fund balances of the plurality of second-grade accounts, wherein the current fund balances of the plurality of second-grade accounts include a maximum fund balance and a minimum fund balance, and the deviation degree is calculated based on the maximum fund balance and the minimum fund balance; and
allocating a fund balance in a target account whose current fund balance is greater than the average value when the deviation degree is greater than a first threshold, wherein the target account is one or more of a plurality of the second-grade accounts.

18. The method according to any of claim 12, further comprising:
by a special account, aggregating part or all of the funds from the second-grade account and releasing the aggregated funds to the first-grade account.

19. The method according to any of claim 12, further comprising:
performing fund distribution among the first-grade account, the second-grade account, and the third-grade account by a fund distribution model of the transaction system, wherein the fund distribution model comprises at least a first distribution model, a second distribution model and a third distribution model; and
performing fund distribution among the first-grade account, the second-grade account, and the third-grade account by a fund distribution model of the transaction system comprises:
when a total amount of funds in the transaction system is less than a second threshold, the fund distribution model is maintained or switched to the first distribution model;
when a quantity of withdrawal services of the transaction system is less than a third threshold, the fund distribution model is maintained or switched to the second distribution model;
when a quantity of withdrawal services of the transaction system is greater than or equal to a fourth threshold, the fund distribution model is maintained or switched to the third distribution model.

20. The method according to 19, wherein the fourth threshold is greater than the third threshold.
